(19) United States
(12) Patent Application Publication
(10) Pub. No.: US 2016/0255829 A1
(43) Pub. Date: Sep. 8, 2016

(54) Bird Net Attachment Device

(71) Applicant: Jason Reger, Roanoke, VA (US)

(72) Inventor: Jason Reger, Roanoke, VA (US)

(21) Appl. No.: 15/061,274

(22) Filed: Mar. 4, 2016

Related U.S. Application Data
(60) Provisional application No. 62/128,653, filed on Mar. 5, 2015.

(51) Int. Cl. A01M 29/32

(52) U.S. Cl. CPC A01M 29/32

(57) ABSTRACT

A bird net attachment device for enabling a user to quickly and securely attach a bird net to a structure. In a preferred embodiment of the present invention, the device comprises at least one elongated member that may be attached to the desired structure and that further comprises (i) a plurality of spaced apart apertures for receiving and retaining a bird net rod, (ii) a plurality of spaced part openings for receiving a portion of said bird net, and (iii) a means for attaching a plurality of elongated members together in series. In a further preferred embodiment of the present invention, the device further comprises at least one connector.

### DROSS-REFERENCE

This application claims priority from Provisional Patent Application Ser. No. 62/128,653 filed Mar. 5, 2015.

### FIELD OF THE INVENTION

This invention relates to an improved bird net attachment device for quick and easy attachment of a bird net to a structure.

### BACKGROUND

Bird netting is a humane and useful tool known in the art for keeping birds from accessing undesirable locations. Notwithstanding, the installation of bird netting can be a time consuming and costly process. For example, heretofore, bird net installers would typically have to (i) attach a plurality of fasteners into the structure to which the netting is to be attached, (ii) run a cable through each of said fasteners, (iii) tighten the cable with the aid of a turnbuckle to remove any slack therein and (iv) attach the bird netting to said cable, typically with metallic rings.

Consequently, there is a long felt need in the art for a device that enables a bird net installer to quickly and securely attach/detach a bird net to a structure such as a wall, beam, truss, etc. There is also a long felt need for a device that is capable of being easily adapted in the field to fit a particular application and/or span with relatively minimal effort. Finally, there is a long felt need for a bird net attachment device that accomplishes all of the forgoing objectives, and that is relatively inexpensive to manufacture and safe and easy to use.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed herein, in one aspect thereof, is a device for enabling a bird net installer to quickly and securely attach/detach a bird net to a structure. In a preferred embodiment of the present invention, the bird net attachment device of the present invention comprises at least one elongated member, wherein said at least one elongated member is further comprised of: (i) a first end and a second end; (ii) at least one fastener opening therein; (iii) a plurality of spaced apart openings for receiving a portion of said bird net; and (iv) a bird net rod retention means. In a further preferred embodiment, said first end has a male insert and said second end has a corresponding female opening such that a plurality of at least one elongated members can be removable attached to one another, or a connector, in series, and said rod retention means is a plurality of clips spaced apart along the body portion for receiving and retaining a length of bird net rod. In a further preferred embodiment of the present invention, the device further comprises at least one connector of similar shape and function to that of said at least one elongated member, but of shorter length, that can be removably attached to elongated member, or another connector, in series.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1A is a rear perspective view of the device of the present invention.

FIG. 1B is a front perspective view of the device of the present invention.

FIG. 2A is a front elevational view of the device of the present invention.

FIG. 2B is a side elevational view of the female end of the device of the present invention.

FIG. 2C is a rear elevational view of the device of the present invention.

FIG. 2D is a side elevational view of the male end of the device of the present invention.

FIG. 2E is a rear elevational view of a portion of the device depicted in FIG. 2C.

FIG. 3A is a rear perspective view of the device connector of the present invention.

FIG. 3B is a front perspective view of the device connector of the present invention.

FIG. 4A is a side elevational view of the female end of the device connector of the present invention.

FIG. 4B is a front elevational view of the device connector of the present invention.

FIG, 5A is a side elevational view of the male end of the device connector of the present invention.

FIG. 5B is a rear elevational view of the device connector of the present invention.

FIG. 6 is a rear perspective view of the male end of the device of the present invention with a bird net rod attached thereto.

FIG. 7 is a front perspective view of the male end of the device of the present invention with a device connector attached thereto.

FIG. 8 is a rear perspective view of the male end of the device of the present invention with a device connector attached thereto.

FIG. 9 is an exploded perspective view of the male end of the device of the present invention and a detached device connector.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details.

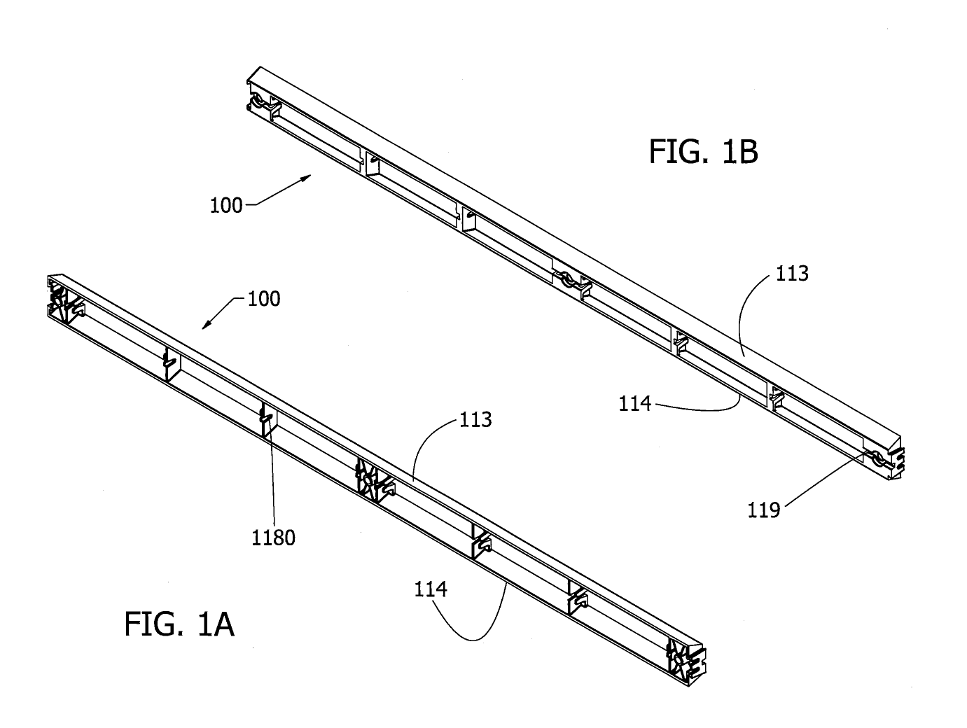

Referring initially to the drawings, FIGS. 1A and 1B depict rear and front perspective views, respectively, of the bird net attachment device 100 of the present invention. In a preferred embodiment, device 100 comprises at least one elongated member 110, at least one fastener opening 120 therein; a plurality of spaced apart openings 130 for receiving a portion of a bird net (not shown) and formed, in part, by a plurality of spaced apart columns 118, and a retention means for securing a bird net rod 200, as described more fully below.

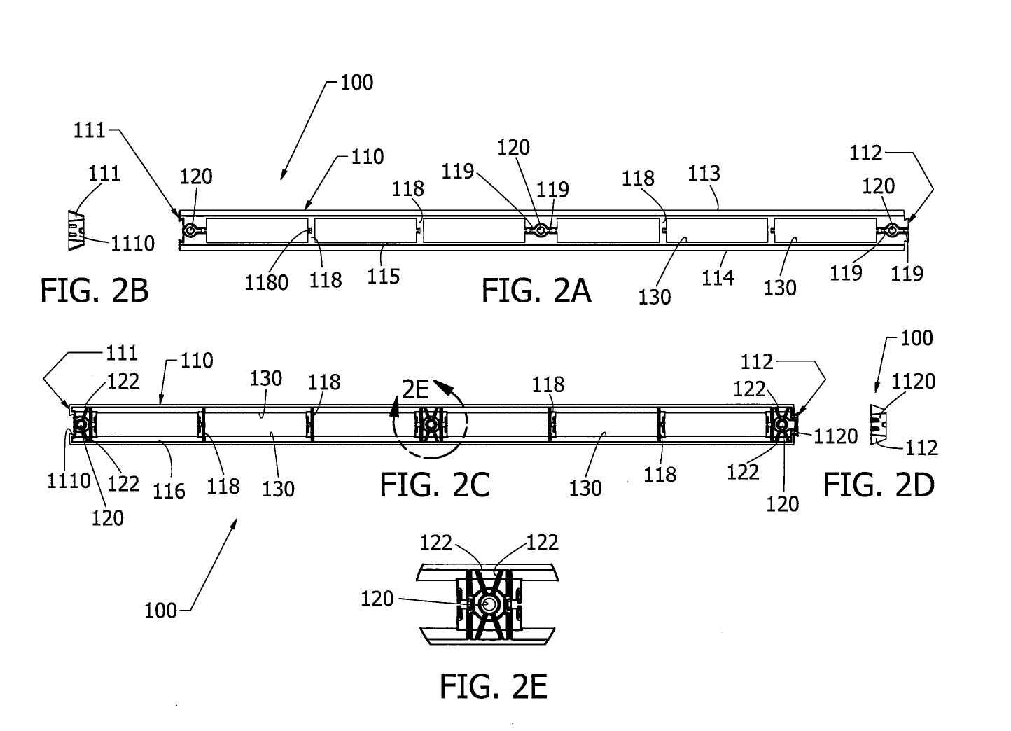

More specifically, elongated member 110 is further comprised of a first end 111, a second end 112, a top 113, a bottom 114, a front 115, a back 116, columns 118, channels 119 and fingers 132, as best shown in FIGS. 1A, 1B and 2A through 2E. Except as otherwise stated herein, device 100 is preferably integrally formed and comprised of a durable material, such as nylon, metal, plastic, etc. While it is contemplated that device 100 can be manufactured in a variety of shapes and sizes to fit a particular application without affecting the overall concept of the present invention, elongated member 110 is preferably: (i) approximately 36 inches in length, as measured between first end 111 and second end 112; (ii) approximately 2 inches in height, as measured from top 113 to bottom 114, though top 113 and bottom 114 may be angled surfaces as shown in FIGS. 1A, 1B, 2B and 2D; and (iii) approximately ¾ of an inch in thickness, as measured between front 115 and back 116.

Fastener openings 120 are continuous openings located along elongated member 110 in spaced apart fashion for receipt of a fastener (not shown) to attach device 100 to a structure, such as a wall, a beam or the like. More specifically, fastener openings 120 are continuous openings that extend from front 115 to back 116, and may be supported structurally by one or more structural ribs 122, as shown in FIG. 2E. Structural ribs 122 may form a general X-like shape, with fastener opening 120 located in the center thereof, and be integrally formed with elongated member 110. Of course, structural ribs 122 can take other forms and shapes as well, and it is also contemplated that device 100 can be attached or fastened to said structures by other means known in the art for attaching a device to a structure.

Columns 118 are also preferably integrally formed with elongated member 110 and located, in spaced apart fashion, along a substantial the length of elongated member 110. Columns 118 extend between top 113 and bottom 114 and, along with top 113 and bottom 114, form openings 130, as best shown in FIGS. 2A and 2C. One or more of said columns 118 may further comprise an aperture 1180 therein for receipt of rod 200, and openings 130 both reduce the overall weight of device 100 and allow for the receipt of portions of a bird net (not shown), which reduces bunching up of the net.

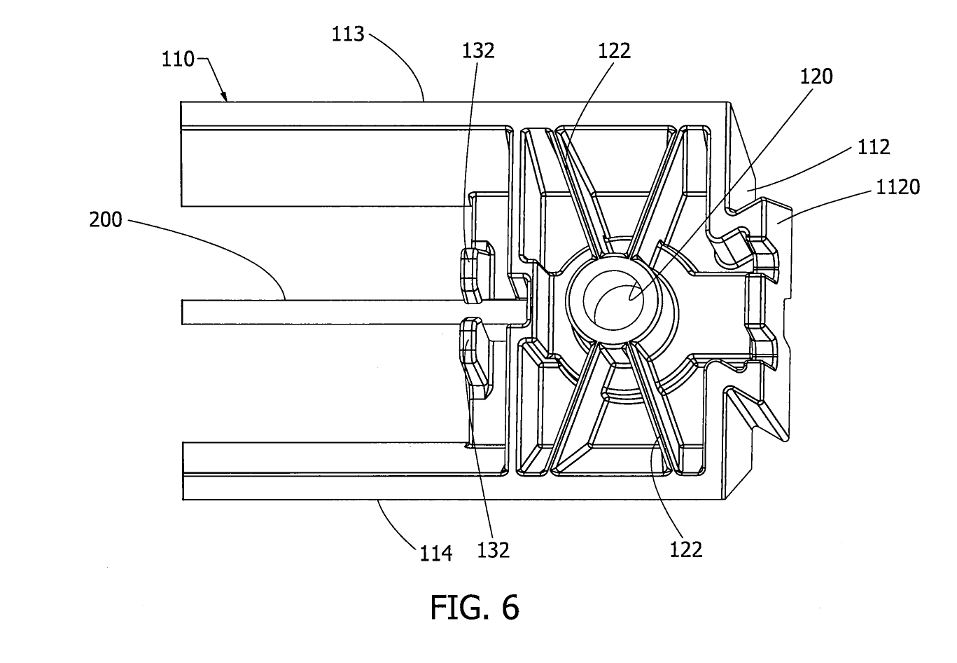

As best illustrated in FIGS. 1B and 2A, channels 119 may also be formed in the front 115 of elongated member 110 adjacent to fastener openings 120 for receipt of a portion of bird net rod 200 or bird net (not shown). Channels 119 help to reduce the bird net from bulging away from the structure and prevent a wave-like appearance in the net in relation to the structure to which it is attached. As best illustrated in FIG. 6, fingers 132 are preferably integrally formed with elongated member 110 and are used to secure rod 200 in a desired position. More specifically, fingers 132 are positioned in spaced apart opposing fashion to retain bird net rod 200, as best shown in FIG. 6.

As best shown in FIGS. 2A through 2D, first end 111 may be further comprised of a dovetail or female opening 1110, and second end 112 may be further comprised of a corresponding dovetail or male insert 1120, or vice versa, so that multiple sections of elongated member 110 can be attached to one another in series by inserting insert 1120 into opening 1110. In this fashion, multiple sections of elongated member 110, and possibly connectors 150 as described below, can be used to install bird netting (not shown) across virtually any length of span. The general dovetail shape of insert 1120 and openings 1110 are tapered to prevent pass-through from one side to the other.

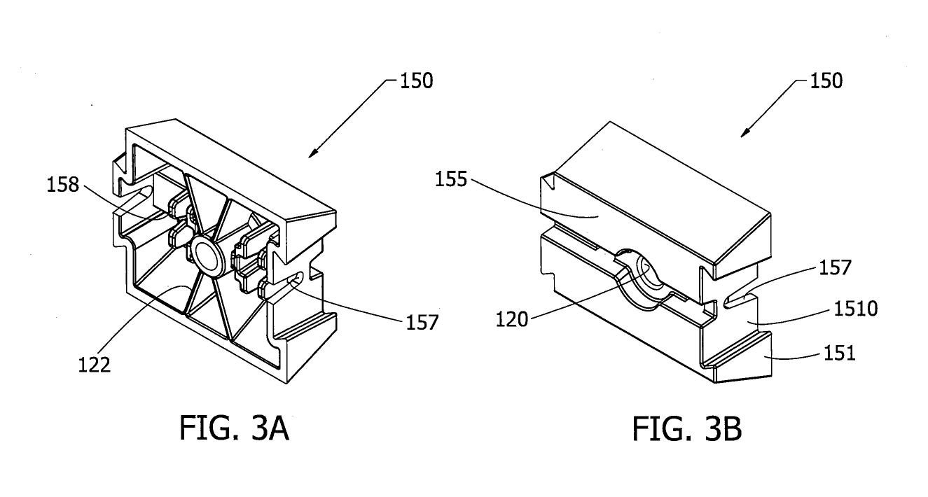

In a further preferred embodiment of the present invent, device 100 further comprises one or more device connectors 150, as best shown in FIGS. 3A and B, 4A and B, 5A and B and 7 through 9. Each of connectors 150 is further comprised of a first end 151, a second end 152, a top 153, a bottom 154, a front 155, a back 156, apertures 157, fingers 158 and channels 159. While it is contemplated that device 100 can be manufactured in a variety of shapes and sizes to fit a particular application without affecting the overall concept of the present invention, each of connectors 150 is preferably: (i) approximately 2½ inches in length, as measured between first end 151 and second end 152; (ii) approximately 2 inches in height, as measured from top 153 to bottom 154, though top 153 and bottom 154 may be angled surfaces as shown in FIGS. 3A and 3B (and similar to elongated member 110); and (iii) approximately ¾ of an inch in thickness, as measured between front 155 and back 156.

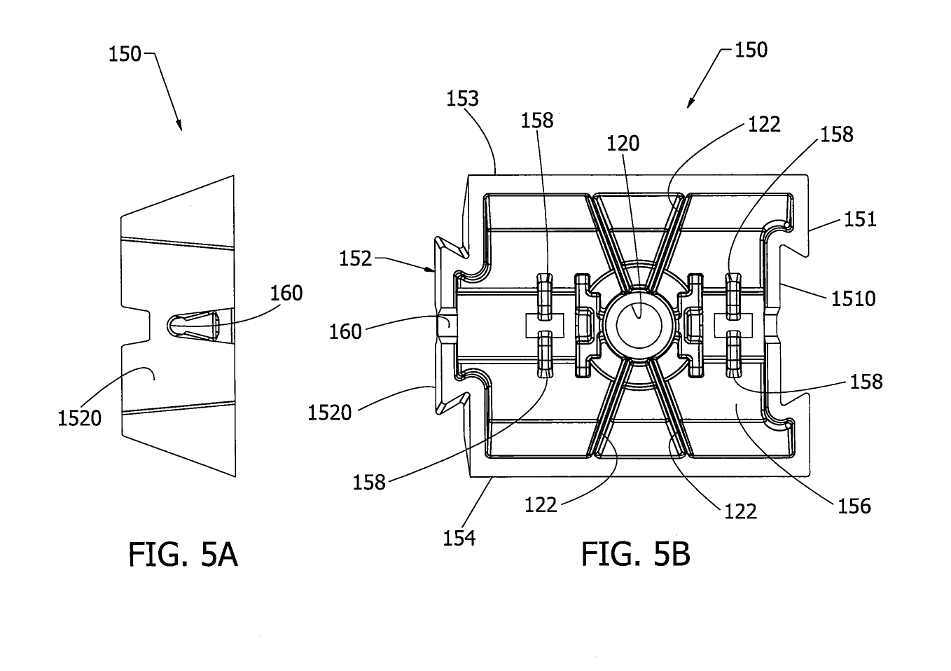

Similar to elongated member 110, connectors 150 may also comprise one or more fastener openings 120 to attach connector 150 to a structure, such as a wall, a beam or the like. More specifically, fastener openings 120 in connector 150 are continuous openings that extend from front 155 to back 156, and may be supported structurally by one or more structural ribs 122. As is the case with elongated member 110 and as shown in FIGS. 3A and 5B, structural. ribs 122 may form a general X-like shape, with fastener opening 120 located in the center thereof, and be integrally formed with connector 150.

As best illustrated in FIGS. 3A and B, 4A and B and 5A and B, and similar to elongated member 110, first end 151 of connector 150 may be further comprised of a dovetail or female opening 1510, and second end 152 may be further comprised of a corresponding dovetail or male insert 1520, or vice versa, so that connector 150 may be removably attached to another connector 150 in series, or to elongated member 110 in series, by inserting insert 1520 into opening 1510 of a connector or opening 1110 of elongated member 110. In this fashion, multiple sections of elongated members 110 and/or connectors 150 can be used to install bird netting (not shown) across virtually any length of span.

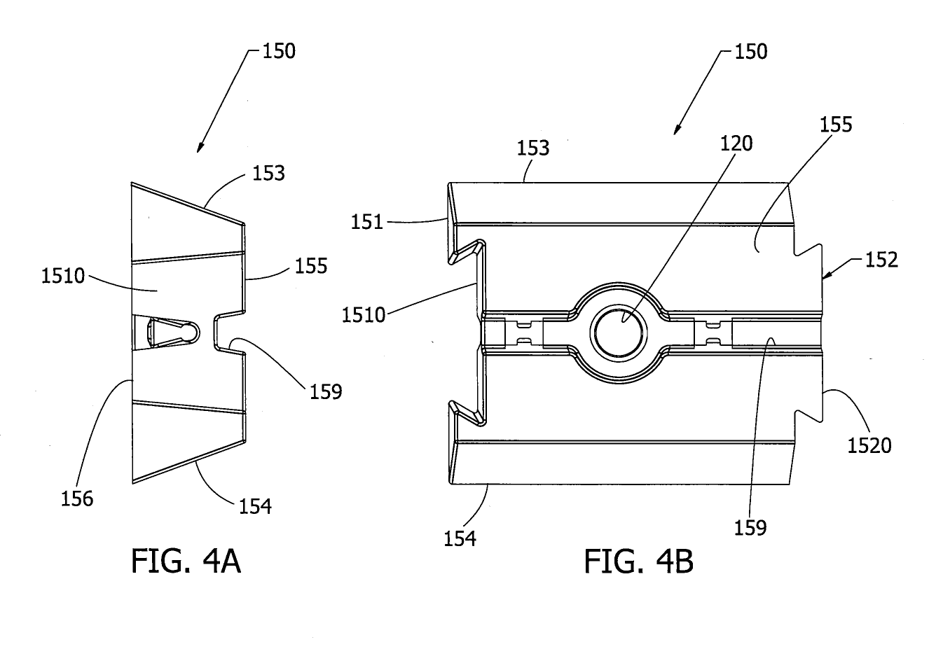

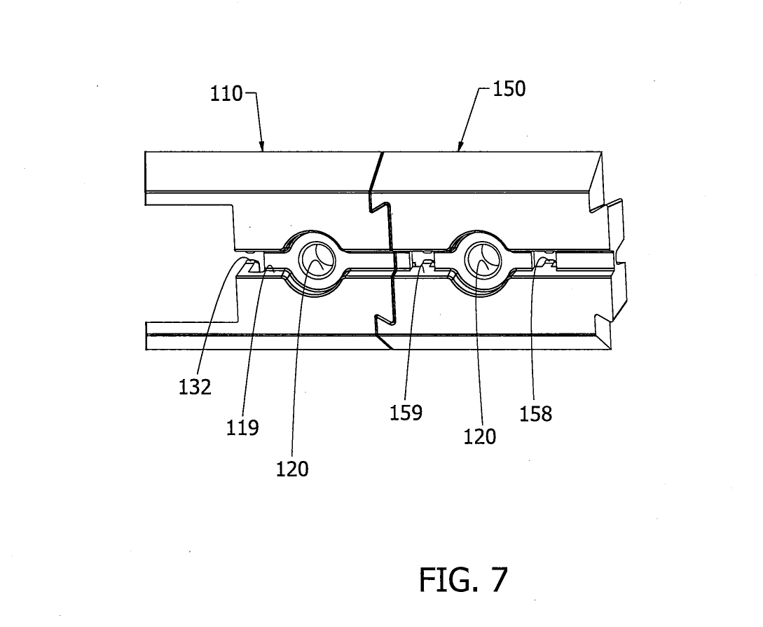

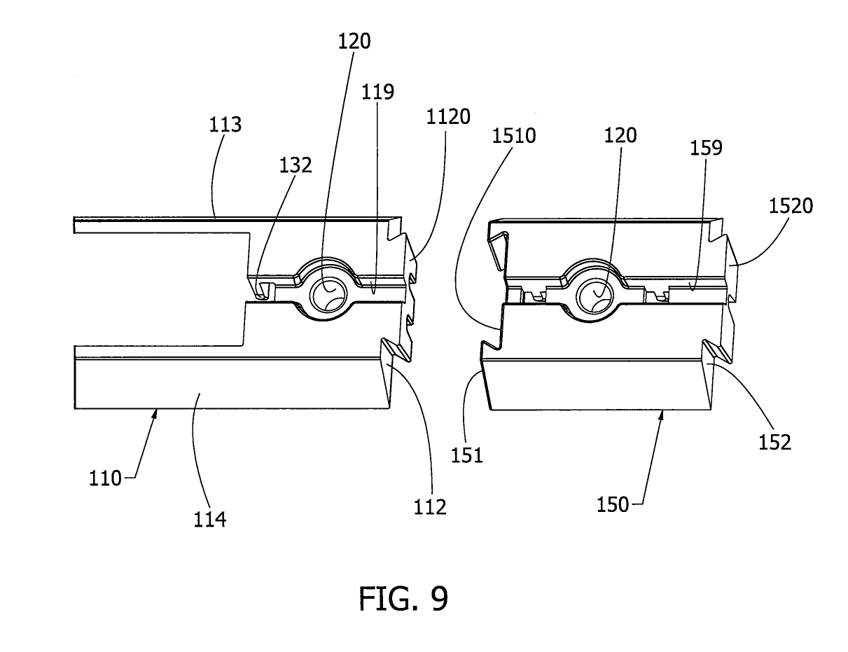

Apertures 157 are similar to apertures 1180 in column 180, and are positioned on first end 151 and second end 152 of connector 150. Apertures 157 are useful for retaining bird net rod 200 in a similar fashion as apertures 1180 described above. Fingers 158 are preferably integrally formed with connector 150 and are used to secure rod 200 in a desired position. As best illustrated in FIGS. 3B and 4B, and similar to the channels 119 in elongated member 110, channels 159 may also be formed in the front 155 of connector 150 adjacent to fastener openings 120 for receipt of a bird net (not shown). Importantly, channels 119 in elongated member 110 should align with channels 159 in connector 150, as shown in FIGS. 7 and 9. In fact, as long as channels 119, 159 are generally aligned, it is not necessary that connector 150 be physically attached to another connector 150 or elongated member 110 because the same may be joined by bird net rod 200. For example, a portion of elongated member 110 may be cut off or removed to fit a small span via the use of a connector 150.

In a further preferred embodiment of the present invention, connector 150 may comprise an opening 160, as best illustrated in FIGS. 5A and B, for receipt of a rod 200. For example, if device 100 is cut to shorten its span and a connector 150 is used, rod 200 (which should be approximately 1″ longer than the cut device 100) may be inserted into opening 160.

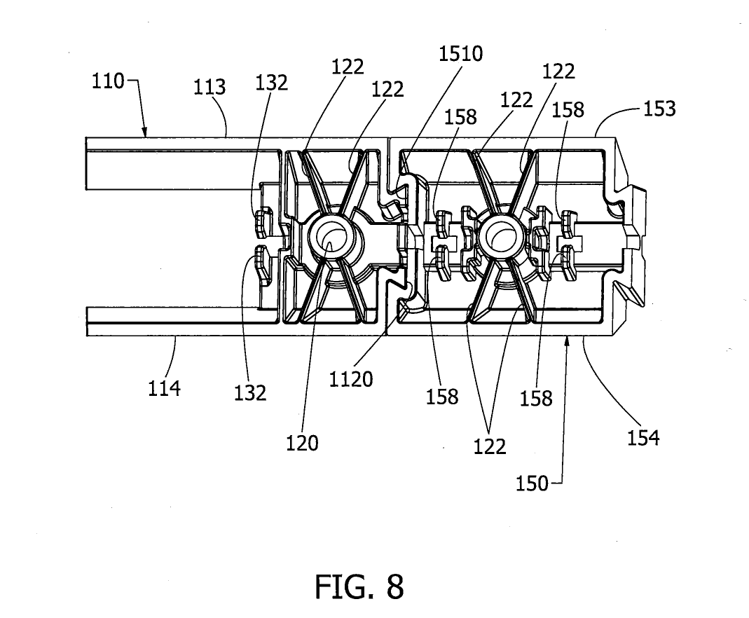

FIG. 6 is a rear perspective view of second end 112 of device 100 with bird net rod 200 attached thereto. More specifically, rod 200 is retained by spaced apart and opposing fingers 132 and channel 119. FIG. 7 is a front perspective view of one end of elongated member 110 matingly engaged with connector 150, while FIG. 8 is a rear perspective view of FIG. 7. FIG. 9 is an exploded perspective view of one end of elongated member 110 in spaced apart relationship with connector 150. Once device 100 is installed, a bird net (not shown) may be attached to rod 200 through the use of rings (also not shown), similar to how a shower curtain is attached to a shower rod via hoops or rings. Alternatively, rod 200 may be weaved into an end of a bird net and then installed onto device 100 and/or connector 150.

Other variations are also within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A device for enabling a user to detachably mount a bird net on a structure comprising:
at least one elongated member, wherein said at least one elongated member is further comprised of:
a first end and a second end;
at least one fastener opening therein;
a plurality of spaced apart openings for receiving a portion of said bird net; and
a bird net rod retention means.

2. The device of claim 1, wherein said first end comprises a male connector and said second end comprises a corresponding female receiver such that a plurality of at least one elongated members can be removable attached to one another in series.

3. The device of claim 1, wherein said bird net rod retention means is comprised of a plurality of fingers and a plurality of columns spaced apart along the at least one elongated member and further wherein each of said plurality of columns is comprised of an aperture therein for receiving and retaining a bird net rod.

4. The device of claim 1 further comprising at least one connector, wherein said at least one connector is comprised of:
a first end and a second end;
at least one fastener opening therein; and
at least one pair of opposing fingers.

5. The device of claim 1 wherein said at least one elongated member further comprises a plurality of structural ribs located adjacent to said at least one fastener opening.

6. The device of claim 1 further comprising a bird net rod.

7. The device of claim 4 wherein a bird net rod is removably attached to at least one of said device and said at least one connector.

8. The device of claim 4 wherein said first end of said connector comprises a male connector and said second end of said connector comprises a female receiver.

9. A device for enabling a user to detachably mount a bird net on a structure comprising:
a first elongated member, wherein said first elongated member further comprises a plurality of fingers, a fastener opening, a plurality of spaced apart columns and a plurality of spaced apart openings adjacent to said plurality of spaced apart columns;
a second elongated member; and
a bird net rod attached to at least one of said first elongated member and said second elongated member.

10. The device of claim 9 wherein each of said first elongated member and said second elongated member further comprises a first end comprised of a male connector and a second end comprised of a female receiver for attaching said first elongated member to said elongated member in series.

11. The device of claim 9 wherein said first elongated member further comprises a plurality of structural ribs located adjacent to said fastener opening.

12. The device of claim 10 further comprising at least one connector, wherein said at least one connector is comprised of:
a first end and a second end;
a fastener opening; and
a pair of fingers.

13. The device of claim 12 wherein said at least one connector further comprises a plurality of structural ribs located adjacent to said fastener opening.

14. The device of claim 12 wherein said first end of said connector comprises a male connector and said second end of said connector comprises a female receiver.

15. The device of claim 14 wherein said connector is attached to said first elongated member or said second elongated member in series.

16. A bird net kit comprising:
a bird net;
at least one bird net rod; and
at least one elongated member, wherein said bird net is removably attached to said at least one bird net rod and said at least one bird net rod is removably attached to and spans a substantial length of said at least one elongated member.

17. The bird net kit of claim 16 further comprising a second elongated member removably attachable to a first end or a second end of said at least one elongated member.

18. The bird net kit of claim 16 further comprising a connector removably attachable to a first end or a second end of said at least one elongated member.

19. The bird net kit of claim 16 wherein said at least one elongated member further comprises at least one structural rib.

20. The bird net kit of claim 16 wherein said at least one elongated member further comprises a fastener opening and a plurality of structural ribs located adjacent to said fastener opening.
